(19) United States
(12) Patent Application Publication
(10) Pub. No.: US 2006/0072193 A1
(43) Pub. Date: Apr. 6, 2006

(54) Electrophoretic display panel

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/525,172

(22) PCT Filed: Jul. 24, 2003
(86) PCT No.: PCT/IB03/03343

§ 371 Date: Feb. 22, 2005

(30) Foreign Application Priority Data
Aug. 26, 2002 (EP) 02078514.3

(51) Int. Cl. G02B 23/00

(52) U.S. Cl. 359/430

(57) ABSTRACT

The electrophoretic display panel for displaying a picture and a subsequent picture, has a first and a second opposed substrate (8,9) an electrophoretic medium between the substrates (8,9), a plurality of pixels (2), a first, a second and a third electrode (3,4,10) associated with each pixel (2) and drive means. The electrophoretic medium has first charged particles having a first color. The drive means are able to control a first, a second and a third potential on the first, the second and the third electrode (3,4,10), respectively, to have picture potential values for displaying the picture, subsequently to have interval potential values before having subsequent picture potential values for displaying the subsequent picture. For the display panel to have pixels (2) with reproducible appearances, the drive means are able to apply reset potential values to the electrodes (3,4,10) as the interval potential values for bringing the charged particles into a predetermined reset position (13) between displaying the picture and displaying the subsequent picture.

The invention relates to an electrophoretic display panel, for displaying a picture and a subsequent picture, comprising:
a first and a second opposed substrate;
an electrophoretic medium between the substrates, the electrophoretic medium comprising first charged particles having a first color;
a plurality of pixels;
a first, a second and a third electrode associated with each pixel; and drive means, being able to control a first, a second and a third potential on the first, the second and the third electrode, respectively, to have picture potential values for displaying the picture, subsequently to have interval potential values before having subsequent picture potential values for displaying the subsequent picture.

An embodiment of the electrophoretic display panel of the type mentioned in the opening paragraph is described in non-prepublished European Patent application 01200952.8 (PHNL 010161).

In the described electrophoretic display panel, a pixel of the plurality of pixels has appearances determined by positions of the first charged particles between the electrodes. The appearance of the pixel, however, depends not only on the potentials, but also on the history of these potentials. To reduce the dependency on the history, the position of the particles is changed to an interval position between displaying the picture and the subsequent picture, as a consequence of the interval potential values of the potentials. The interval position serves as a starting position for changing the position of the particles to display the subsequent picture. However, the dependency of the appearance of the pixel on the history is still relatively large. Therefore, it is difficult to have substantially reproducible appearances of the pixel.

It is a drawback of the described display panel that it is difficult to obtain therewith pixels with substantially reproducible appearances.

It is an object of the invention to provide a display panel of the kind mentioned in the opening paragraph which has pixels with substantially reproducible appearances.

The object is thereby achieved that the drive means are able to apply reset potential values to the electrodes as the interval potential values for bringing the charged particles into a predetermined reset position between displaying the picture and displaying the subsequent picture.

The invention is based on the insight that if the charged particles are brought into the predetermined reset position as the interval position, the interval position previous to the subsequent picture is substantially equal to the interval position previous to each following picture. Therefore, a dependency of the appearance of the pixel on the history of the potentials is substantially absent. The drive means of the display panel according to the invention are able to bring the charged particles into the predetermined reset position between displaying the picture and displaying the subsequent picture by the application of reset potential values to the electrodes as the interval potential values. Therefore, the display panel has pixels with substantially reproducible appearances.

This is in contrast to the display panel described in non-prepublished European Patent application 01200952.8 (PHNL 010161), where the interval positions are brought about by predetermined potential values as interval potential values. The interval positions are, as a result thereof, strongly dependent on the positions during the display of the preceding picture. It is therefore not possible to get substantially reproducible appearances of the pixels in the subsequent picture.

If the first substrate comprises for each pixel the first electrode, and the second substrate comprises for each pixel the second and the third electrode, the appearances of the pixels can relatively easy be changed compared to the display panel having one of the substrates comprising the first, the second and the third electrode. Alternatively, many other pixel geometries are possible.

If the reset potential values are opposite to the picture potential values and the drive means are able to apply the reset potential values for a same duration as the picture potential values, before applying the subsequent picture potential values, the trajectory of the charged particles is opposite to the trajectory of the charged particles as a consequence of the picture potential values. As a result the charged particles are substantially brought back into the positions occupied before displaying the picture. If the picture potential value of one of the potentials is zero, the respective reset potential value is also zero. As a result the interval position of the charged particles is equal for each following picture. The display panel may have a similar structure as the display panel described in non-prepublished European Patent application 01200952.8 (PHNL 010161), having only different picture potential values between displaying the picture and displaying the subsequent picture.

If the predetermined reset position is an extreme position, the reset potential values are opposite to the picture potential values and the drive means are able to apply the reset potential values for at least a same duration as the picture potential values, before applying the subsequent picture potential values, the trajectory of the charged particles is opposite to the trajectory of the charged particles as a consequence of the picture potential values. The reset potential values may be applied for a longer duration than the duration of the picture potential values, and are therefore less critical, because the predetermined reset position is an extreme position, i.e. the position of the charged particles does not change if the reset potential values are applied for a longer duration than the picture potential values. As a result the charged particles are substantially brought back into the positions occupied before displaying the picture.

In another embodiment the first charged particles consist of one of negatively charged particles and positively charged particles, and the drive means are able to apply the reset potential values to the electrodes for bringing the charged particles into the predetermined reset position, which is associated with the first electrode. Then the first charged particles are concentrated near the first electrode, which is relatively small compared with pixel dimensions. If the first charged particles consist of negatively charged particles, the reset potential value of the first electrode is high as compared to the reset potential value of each of the second and the third electrode. If the first charged particles consist of positively charged particles, the reset potential value of the first electrode is low as compared to the reset potential value of each of the second and the third electrode.

In another embodiment the first charged particles consist of one of negatively charged particles and positively charged particles, and for each pixel a fourth electrode is present distant from the second substrate, and being able to receive a fourth potential from the drive means for bringing the charged particles into the predetermined reset position, which is associated with the fourth electrode. The drive means are able to apply reset potential values to the four electrodes for bringing the charged particles into the predetermined reset position, which is associated with the fourth electrode. If the first charged particles consist of negatively charged particles, the reset potential value of the fourth electrode is high as compared to the reset potential value of each of the first, the second and the third electrode. If the first charged particles consist of positively charged particles, the reset potential value of the fourth electrode is low as compared to the reset potential value of each of the first, the second and the third electrode. When the first charged particles are for instance concentrated near the fourth electrode, the first charged particles are in the predetermined reset position, which is associated with the fourth electrode. This embodiment has the advantage that the pixels have even better reproducible appearances.

In another embodiment the first charged particles are negatively charged, the electrophoretic medium further comprises second charged particles having a second color and a positive charge, and for each pixel a fourth and a fifth electrode are present distant from the second substrate and able to receive a fourth and a fifth potential, respectively from the drive means for bringing the charged particles into the predetermined reset position, which is associated with the fourth and the fifth electrode, respectively. The drive means are able to apply reset potential values to the five electrodes for bringing the first and the second charged particles into the predetermined reset position, which is associated with the fourth and the fifth electrode, respectively. To bring the first charged particles in the predetermined reset position, which is associated with the fourth electrode, and to bring the second charged particles in the predetermined reset position, which is associated with the fifth electrode, the reset potential value of the fourth electrode is high as compared to the reset potential value of each of the first, the second, the third and the fifth electrode and the reset potential value of the fifth electrode is low as compared to the reset potential value of each of the first, the second, the third and the fourth electrode. When the first charged particles are in the predetermined reset position, which is associated with the fourth electrode, the first charged particles are for instance concentrated near the fourth electrode. When the second charged particles are in the predetermined reset position, which is associated with the fifth electrode, the second charged particles are for instance concentrated near the fifth electrode. This embodiment has the advantage that the pixels have even better reproducible appearances.

These and other aspects of the invention will be further elucidated and described with reference to the drawings, in which:

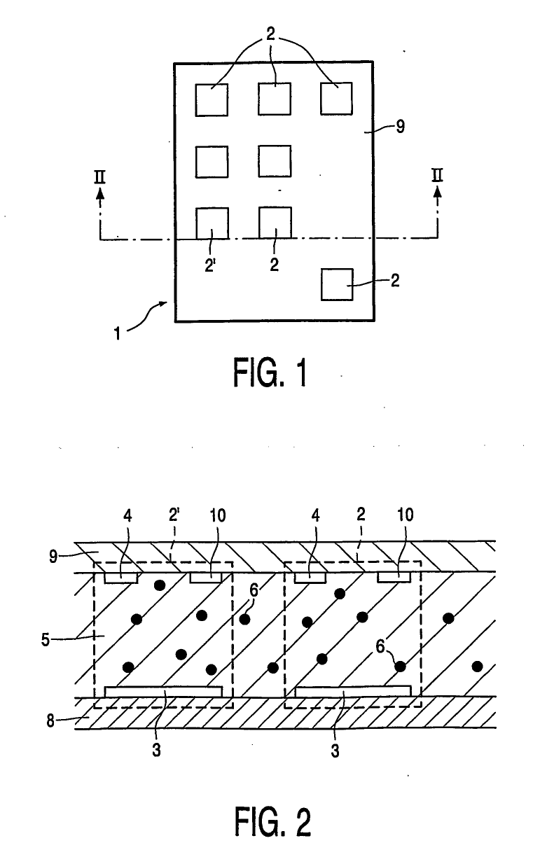

FIG. 1 shows diagrammatically a front view of an embodiment of the display panel;

FIG. 2 shows diagrammatically an embodiment of a cross-sectional view along II-II in FIG. 1;

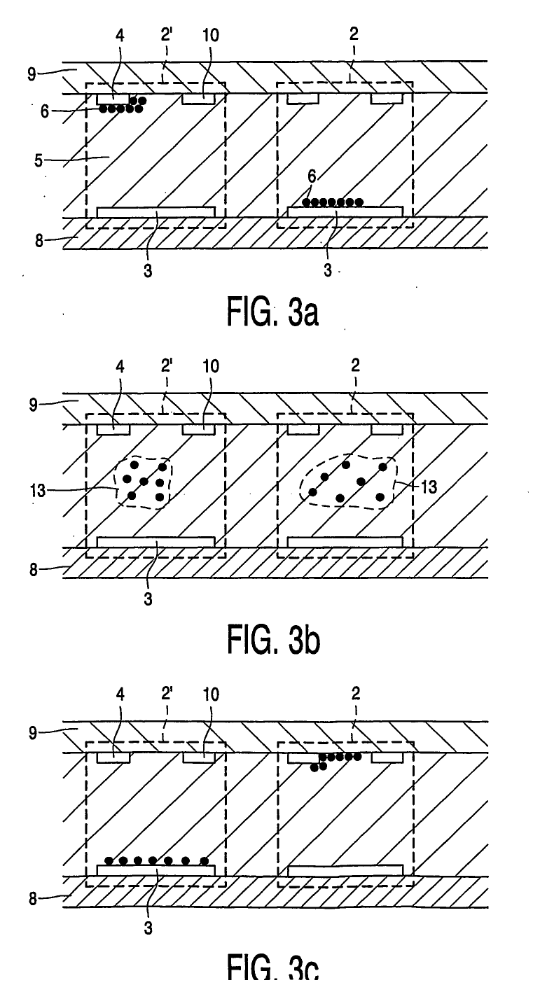

FIG. 3a shows diagrammatically the embodiment of FIG. 2 if the electrodes have picture potential values;

FIG. 3b shows diagrammatically the embodiment of FIG. 2 if the electrodes have reset potential values;

FIG. 3c shows diagrammatically the embodiment of FIG. 2 if the electrodes have subsequent picture potential values;

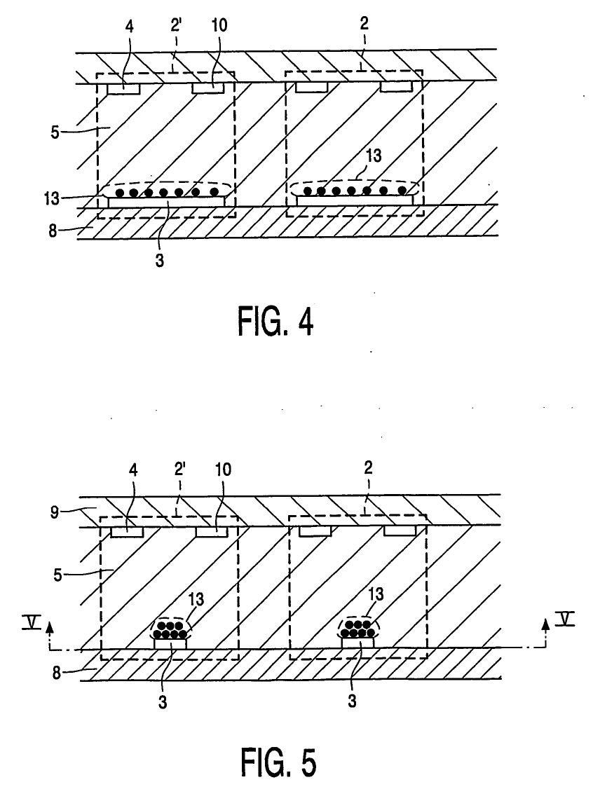

FIG. 4 shows diagrammatically a cross-sectional view along II-II in FIG. 1 of a second embodiment if the electrodes have reset potential values;

FIG. 5 shows diagrammatically a cross-sectional view along II-II in FIG. 1 of a third embodiment if the electrodes have reset potential values;

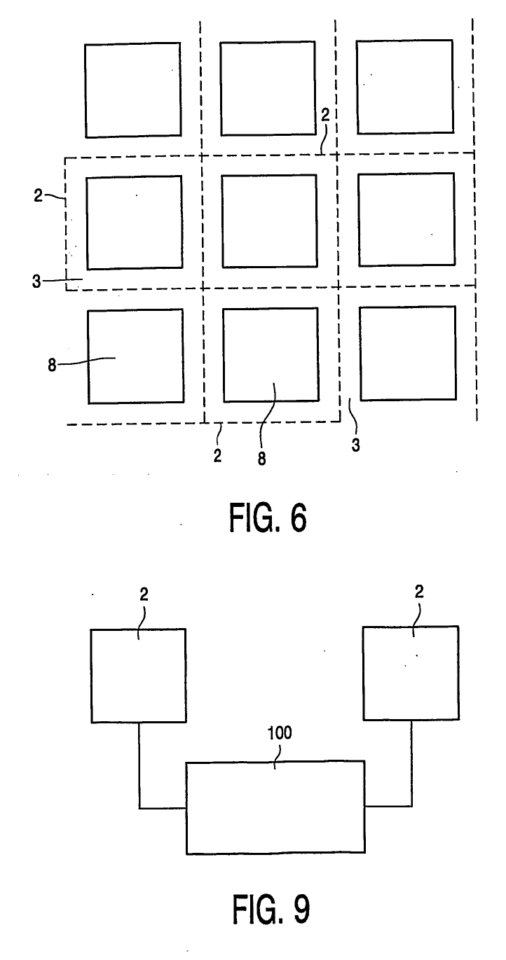

FIG. 6 shows diagrammatically a cross-sectional view along V-V in FIG. 4 of a fourth embodiment;

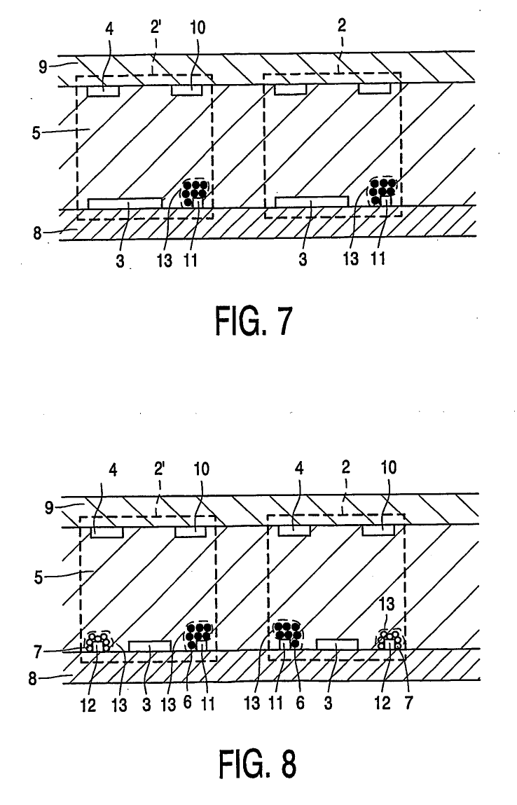

FIG. 7 shows diagrammatically a cross-sectional view along II-II in FIG. 1 of a fifth embodiment if the electrodes have reset potential values;

FIG. 8 shows diagrammatically a cross-sectional view along II-II in FIG. 1 of a sixth embodiment if the electrodes have reset potential values; and

FIG. 9 shows diagrammatically a portion of the display panel.

The Figures are schematic and not drawn to scale and in all the Figures corresponding parts are referenced to by the same reference numerals.

FIG. 1 shows the display panel 1 having a second substrate 9 and a plurality of pixels 2. The pixels 2 are for instance arranged along substantially straight lines in a two-dimensional structure.

FIG. 2 shows the display panel 1 having a first substrate 8 and a second opposed substrate 9. An electrophoretic medium 5 is present between the substrates 8,9. The electrophoretic medium 5 comprises first charged particles 6, having a first color, in a fluid. As an example, the first charged particles 6 are black and have a negative charge, and the fluid is white. Such electrophoretic medium can be obtained from E Ink Corporation. A first, a second and a third electrode (3,4,10) are associated with each pixel (2). In the Figure the first substrate 8 has for each pixel 2, a first electrode 3, and the second substrate 9 has for each pixel 2 a second electrode 4 and a third electrode 10. The first, the second and the third electrode 3,4,10 are able to receive a first, a second and a third potential, respectively.

FIG. 3a shows the electrodes 3,4,10 having picture potential values for displaying the picture. The picture potential values of the first, the second and third electrode 3,4,10 of pixel 2′ are for instance 0, 10 and 5 Volts, respectively. The negatively charged black particles 6 are present near the second electrode 4 and the pixel 2′ has a gray appearance. The picture potential values of the first, the second and third electrode 3,4,10 of pixel 2 may be different from the picture potential values of pixel 2′.

Subsequently, between displaying the picture and displaying the subsequent picture, the electrodes 3,4,10 in FIG. 3b have reset potential values as the interval potential values. As a consequence, the charged particles 6 are in the predetermined reset position 13. The reset potential values are for instance opposite to the picture potential values and the reset potential values and the picture potential values have been applied for a same duration. The reset potential values of the first, the second and third electrode 3,4,10 of pixel 2′ are, related to the example given in FIG. 3a, then 0, −10 and −5 Volts, respectively.

Subsequently, in FIG. 3c, the electrodes 3,4,10 have subsequent picture potential values for displaying the subsequent picture. The subsequent picture potential values of the first, the second and third electrode 3,4,10 of pixel 2′ are for instance 10, 0 and 0 Volts, respectively. The negatively charged black particles are present near the first electrode 3 and the pixel 2′ has a white appearance.

In FIG. 4 the electrodes 3,4,10 have reset potential values as the interval potential values between displaying the picture and displaying the subsequent picture. The predetermined reset position 13 is an extreme position, in the Figure near the first electrode 3. The reset potential values are opposite to the picture potential values and the reset potential values have been applied for at least a same duration as the picture potential values. As a consequence, the charged particles 6 are in the predetermined reset position 13.

FIG. 5 shows the first electrode 3, which is small compared with pixel 2 dimensions. The electrodes 3,4,10 have reset potential values. The first charged particles 6 are in the predetermined reset position 13, which is associated with the first electrode 3. If the first charged particles 6 have a negative charge, the reset potential values of the first, the second and the third electrode 3,4,10 of pixel 2′ are for instance −15, 0, 0 Volts, respectively. If the first charged particles 6 have a positive charge, the reset potential values of the first, the second and the third electrode 3,4,10 of pixel 2′ are for instance −15, 0, 0 Volts, respectively. In both cases, the first charged particles 6 are concentrated near the first electrode 3.

In FIG. 6 the first electrodes 3 of a number of pixels 2 are integral. Furthermore, for each pixel the first electrode 3 is present on a small portion, compared to pixel 2 dimensions, of the first substrate 8. When the first charged particles 6 are in the predetermined reset position 13, which is associated with the first electrode 3, the first charged particles 6 are concentrated near the first electrode 3.

FIG. 7 shows a fourth electrode 11, which is present distant from the second 5 substrate 9, in the Figure at the first substrate 8. The electrodes 3,4,10,11 have reset potential values. The first charged particles 6 are in the predetermined reset position 13, which is associated with the fourth electrode 11. If the first charged particles 6 have a negative charge, the reset potential values of the first, the second, the third and the fourth electrode 3,4,10,11 of pixel 2′ are for instance 0, 0, 0, 15 Volts, respectively. If the first charged particles 6 have a positive charge, the reset potential values of the first, the second, the third and the fourth electrode 3,4,10,11 of pixel 2′ are for instance 0, 0, 0, −15 Volts, respectively. In both cases, the first charged particles 6 are concentrated near the fourth electrode 11.

FIG. 8 shows the first charged particles 6 being negatively charged and, as an example, black. Furthermore, the electrophoretic medium 5 has second charged particles 7, which have a positive charge and, as an example, are white. The fluid of the electrophoretic medium 5 is for instance transparent. For each pixel 2 a fourth electrode 11 and a fifth electrode 15 are present at the first substrate 8. The electrodes 3,4,10,11,12 have reset potential values. The first charged particles 6 are in the predetermined reset position 13, which is associated with the fourth electrode 11. The second charged particles 7 are in the 20 predetermined reset position 13, which is associated with the fifth electrode 12. The reset potential values of the first, the second, the third, the fourth and the fifth electrode 3,4,10,11,12 of pixel 2′ are for instance 0, 0, 0, 15, −15 Volts, respectively. The first charged particles 6 are concentrated near the fourth electrode 11, and the second charged particles 7 are concentrated near the fifth electrode 12.

FIG. 9 shows diagrammatically the display panel 1 comprising pixels 2 and the drive means 100. The drive means 100 are able to control the first, the second and the third potential on the first, the second and the third electrode 3,4,10, respectively, of each pixel 2, to have picture potential values for displaying the picture, subsequently to have reset potential values for bringing the charged particles 6,7 into a predetermined reset position 13 before having subsequent picture potential values for displaying the subsequent picture. Furthermore, if the fourth electrode 11 is present the drive means 100 are able to control the fourth potential of the fourth electrode 11 for bringing the charged particles 6 into the predetermined reset position 13, which is associated with the fourth electrode 11. If, furthermore, the fifth electrode 12 is present the drive means 100 are able to control the fifth potential of the fifth electrode 12 for bringing the charged particles 7 into the predetermined reset position 13, which is associated with the fifth electrode 12.

It will be apparent that within the scope of the invention many variations are possible for a person skilled in the art.

1. An electrophoretic display panel, for displaying a picture and a subsequent picture, comprising:
a first and a second opposed substrate;
an electrophoretic medium between the substrates, the electrophoretic medium comprising first charged particles having a first color;
a plurality of pixels;
a first, a second and a third electrode associated with each pixel; and
drive means, being able to control a first, a second and a third potential on the first, the second and the third electrode, respectively, to have picture potential values for displaying the picture, subsequently to have interval potential values before having subsequent picture potential values for displaying the subsequent picture, characterized in that
the drive means are able to apply reset potential values to the electrodes as the interval potential values for bringing the charged particles into a predetermined reset position between displaying the picture and displaying the subsequent picture.

2. A display panel as claimed in claim 1, characterized in that the first substrate comprises for each pixel the first electrode, and the second substrate comprises for each pixel the second and the third electrode.

3. A display panel as claimed in claim 1, characterized in that the reset potential values are opposite to the picture potential values and the drive means are able to apply the reset potential values for a same duration as the picture potential values, before applying the subsequent picture potential values.

4. A display panel as claimed in claim 1, characterized in that the predetermined reset position is an extreme position, the reset potential values are opposite to the picture potential values and the drive means are able to apply the reset potential values for at least a same duration as the picture potential values, before applying the subsequent picture potential values.

5. A display panel as claimed in claim 1, characterized in that the first charged particles consist of one of negatively charged particles and positively charged particles, and the drive means are able to apply the reset potential values to the electrodes for bringing the charged particles into the predetermined reset position, which is associated with the first electrode.

6. A display panel as claimed in claim 1, characterized in that the first charged particles consist of one of negatively charged particles and positively charged particles, and for each pixel a fourth electrode is present distant from the second substrate, and being able to receive a fourth potential from the drive means for bringing the charged particles into the predetermined reset position, which is associated with the fourth electrode.

7. A display panel as claimed in claim 1 characterized in that the first charged particles are negatively charged, the electrophoretic medium further comprises second charged particles having a second color and a positive charge, and for each pixel a fourth and a fifth electrode are present distant from the second substrate and able to receive a fourth and a fifth potential, respectively from the drive means for bringing the charged particles into the predetermined reset position, which is associated with the fourth and the fifth electrode, respectively.
